(19) United States
(12) Patent Application Publication
(10) Pub. No.: US 2006/0143330 A1
(43) Pub. Date: Jun. 29, 2006

(54) Method for data transmit burst length control

(76) Inventor: Oliver Kiehl, Charlotte, VT (US)

Correspondence Address: SLATER & MATSIL LLP, 17950 PRESTON ROAD, SUITE 1000, DALLAS, TX, 75252, US

(21) Appl. No.: 11/021,704

(22) Filed: Dec. 23, 2004

(51) Int. Cl. G06F 13/28

(52) U.S. Cl. 710/35

(57) ABSTRACT

Method for controlling the burst length of a data transmission. A preferred embodiment comprises initiating a fixed burst length transmission and issuing a burst terminate command specifying a desired length of the burst data transfer, wherein the burst terminate command is issued prior to the completion of the fixed burst length data transfer. The burst terminate command specifies an address of a final data to be transferred by the fixed burst length transmission.

### TECHNICAL FIELD

The present invention relates generally to a method for digital communications, and more particularly to a method for controlling the burst length of a data transmission.

### BACKGROUND

The transmission of a burst of data can be an effective way to increase the communications efficiency of a communications system. The transmission of a burst of data rather than a single unit of data can increase efficiency by increasing the amount of data transmitted for an approximately equal amount of communications overhead. Communications overhead may include set up messages or signals and tear down messages or signals along with latency associated with the messages or signals. For example, sixteen (16) units of data can be transmitted using substantially the same amount of communications overhead used to transmit a single unit of data. The communications efficiency can be further increased by fixing the length of the burst of data being transmitted. The fixed length burst can increase efficiency since it is not necessary to specify the length of the transmission burst, further reducing communications overhead.

However, the communications system, be it a network of computers connected via a communications network or a computer (or digital device) that is reading and writing data to a local memory, may occasionally wish to transmit less data than what is transmitted using a single fixed length burst transmission. One way to transmit data when there is less data to transmit than what is required by the fixed length burst transmission is to revert to the technique of transmitting data in single units. The use of the single unit data transmissions can permit the transmission of any arbitrary number of data units.

Another technique that can be used to transmit less data than what is required by the fixed length burst transmission is to transmit what is desired and then mask out any remaining data units. This technique is commonly used in memory systems. For example, in the double data rate (DDR) and double data rate two (DDR2) synchronous dynamic random access memory (SDRAM) technical standards, as specified in technical standards entitled: JEDEC Standard “Double Data Rate (DDR) SDRAM Specification—JESD79D” (DDR SDRAM) and “DDR2 SDRAM Specification—JESD79-2,” (DDR2 SDRAM), a pin on the memory module referred to as the data mask (DM) pin can be used to mask out portions of the data being exchanged.

Yet another technique that is used in certain memory systems is to terminate a fixed length burst data read exchange using a burst terminate command. A burst terminate command can be issued to terminate a fixed length burst data read exchange.

One disadvantage of the prior art is that the use of single data unit transmissions incurs high communications overhead and can greatly reduce communications efficiency.

A second disadvantage of the prior art is that the use of additional pins (such as the DM pin) can increase the overall cost of the device since a significant number of additional pins may be required.

Yet another disadvantage of the prior art is that while the use of the DM pin will stop the transfer of data after the transmission of the last desired data unit, the communications bus can still be occupied until the entire fixed length burst is transmitted. This can lead to an under utilized and therefore inefficient communications bus.

Another disadvantage of the prior art is that the use of a command to terminate the fixed length burst data read exchange incurs a fixed latency. Therefore, the terminate command will not work properly with transmissions that finish transmitting data before the burst terminate command can execute.

Yet another disadvantage of the prior art is that the issuance of a command to terminate the fixed length burst data transfer exchange cannot occur at any time after the initial read or write command. There are situations, such as in a multi-bank memory system, wherein a command slot immediately following the fixed length burst data transfer exchange is already occupied by another command.

### SUMMARY OF THE INVENTION

These and other problems are generally solved or circumvented, and technical advantages are generally achieved, by preferred embodiments of the present invention which provides a method for controlling the length of a burst transmission.

In accordance with a preferred embodiment of the present invention, a method for shortening a fixed burst length data transfer is provided. The method comprises initiating a fixed burst length data transfer, and issuing a burst terminate command specifying a desired length of the burst data transfer, wherein the burst terminate command is issued prior to the completion of the fixed burst length data transfer.

In accordance with another preferred embodiment of the present invention, a method for shortening fixed length burst transfers in a memory system is provided. The method comprises placing a burst transfer command on a command bus and a first memory address on an address bus, wherein the first memory address specifies a starting address of data to be transferred, and after a burst transfer starts, placing a burst terminate command on the command bus and a second memory address on the address bus, wherein the second memory address specifies a terminating address of data to be transferred.

An advantage of a preferred embodiment of the present invention is that an implementation of the present invention on a memory system does not require any additions or modifications to the hardware, such as the addition of input/output pins. This can ease the implementation of a preferred embodiment of the present invention on communications systems already deployed.

A further advantage of a preferred embodiment of the present invention is that the use of a preferred embodiment of the present invention does not incur a latency and the transmission of data can stop immediately after the last desired data unit is transmitted.

Yet another advantage of a preferred embodiment of the present invention is that after the last desired data unit is transmitted, the communications bus becomes free and can be used to transmit other data.

Another advantage of a preferred embodiment of the present invention is that the burst terminate command can be issued at any time after the issuance of the fixed length burst data transfer command. This can be advantageous in certain systems wherein command instruction slots immediately following the fixed length burst data transfer command are already occupied.

A further advantage of a preferred embodiment of the present invention is that the burst terminate command can terminate a fixed length burst data transfer after an even number or an odd number of data units transferred with equal efficiency.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIGS. 1a and 1b are diagrams of an exemplary computer system and an exemplary communications network;

FIGS. 2a and 2b are diagrams of a fixed length burst transfer of data to and from a memory in a computer system;

FIG. 3 is a diagram of a prior art technique for transferring fewer data units than a fixed length burst transfer;

FIG. 4 is a diagram of an exemplary fixed length burst transfer after the execution of a modified burst terminate command, wherein it is desired to terminate the burst transfer after six data units have been transferred, according to a preferred embodiment of the present invention;

FIGS. 5a and 5b are diagrams of the use of the burst terminate command to reduce the number of data units transferred in a fixed length burst transfer, according to a preferred embodiment of the present invention; and

FIGS. 6a and 6b are diagrams of the use of the burst terminate command to reduce the number of data units transferred in a fixed length burst transfer in a memory system, according to a preferred embodiment of the present invention.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to preferred embodiments in a specific context, namely a memory system in a digital device that is adherent to a SDRAM technical standard, such as DDR, DDR2, and subsequent standards such as DDR3, DDR4, and so forth. The invention may also be applied, however, to other memory systems for use in a digital device as well as communications networks wherein one digital device can put (write) data to another digital device or get (read) data from another digital device.

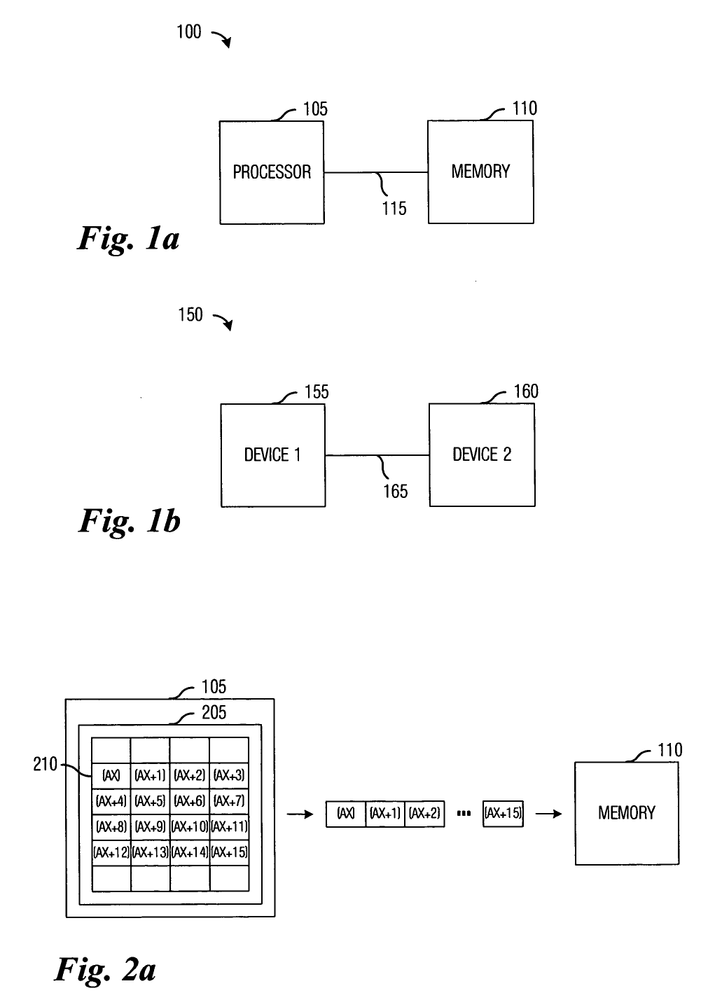

With reference now to FIGS. 1a and 1b, there are shown diagrams illustrating portions of an exemplary computer system 100 and an exemplary communications network 150. The diagram shown in FIG. 1a illustrates a portion of the exemplary computer system 100, wherein only a processor 105 and a memory 110 are shown. Other components of the exemplary computer system 100, such as the video device, the input/output devices, and so forth, are not shown to maintain simplicity of the diagram. The memory 110 may be solid-state memory, such as random access memory (RAM), read-only memory (ROM), other solid-state memory devices, and so forth, or secondary memory, such as hard drives, floppy drives, optical drives, and so on. Connecting the processor 105 to the memory 110 may be a connection 115. The connection 115 may be a high-speed communications bus, such as a dedicated processor/memory bus, a peripherals interconnection (PCI) bus, a serial bus, and so on.

The processor 105 can access data stored in the memory 110 through read and write commands issued to a memory controller (not shown). The memory controller can interpret the commands of the processor 105 and perform the requested operation. For example, the processor 105 can provide a read command along with a memory address and the memory controller can perform the command and provide the processor 105 with the contents of the memory address.

The diagram shown in FIG. 1b illustrates a portion of the exemplary communications network 150, wherein only two devices, a device 1 155 and a device 2 160, are shown. Note that the exemplary communications network 150 may include other devices, but these other devices are not shown in FIG. 1b to maintain simplicity. Connecting the device 1 155 and the device 2 160 can be a communications link 165. The communications link 165 can permit the sharing of information between the device 1 155 and the device 2 160.

One of the devices, such as the device 1 155, can communicate with the other device, such as the device 2 160, through commands to put and get data. The device 1 155 can execute a command, such as the put command that can result in a message being passed to the device 2 160. The message can contain the data being provided to the device 2 160. The device 2 160 can then take the data provided in the message and store it, perhaps in a position specified by the device 1 155.

The configuration of the computer system 100 and the communications network 150 shown in FIGS. 1a and 1b are similar and the discussion of the computer system 100 can also be applicable to the communications network 150. Therefore, subsequent discussion will be focused on the computer system 100 and communications between the processor 105 and the memory 110. It should be clear to a person of ordinary skill in the art of the present invention, that the discussion and the techniques described can be made applicable to a communications network with minor adjustments. Thusly, this discussion should not be construed as limiting the spirit of the present invention solely to that of a computer system.

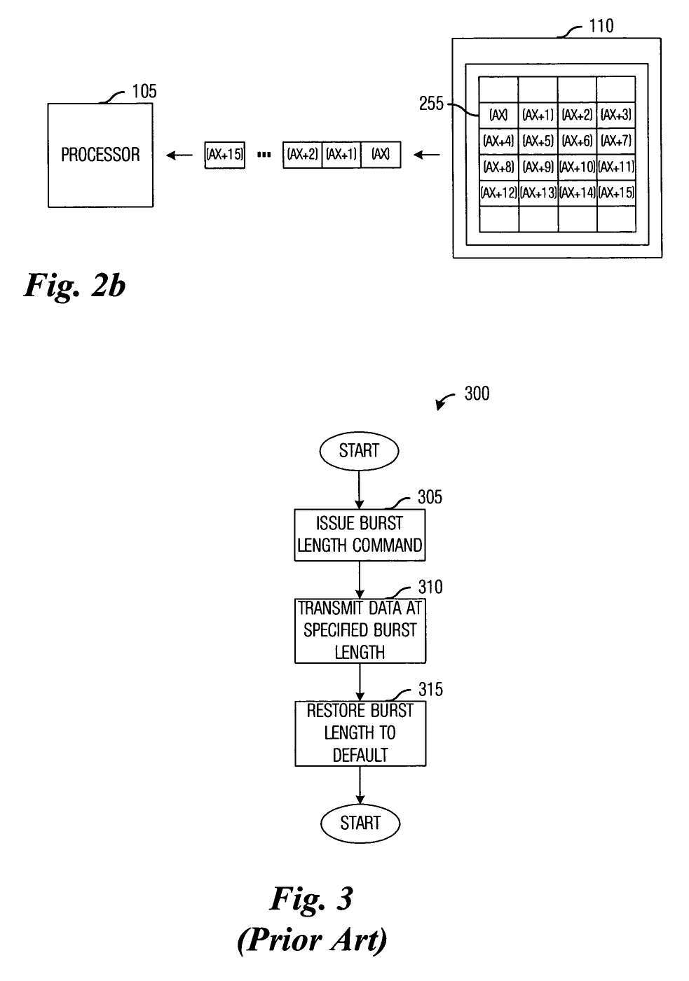

With reference now to FIGS. 2a and 2b, there are shown diagrams illustrating the fixed length burst transfer of data to and from the memory 110 in the computer system 100. Note that while the diagrams in the figures illustrate the transfer of data in the computer system 100, the diagrams can also illustrate the transfer of data between devices in the communications network 150. The diagram in FIG. 2a illustrates data being transferred from the processor 105 to the memory 110, via a write command, for example. If the diagram had been illustrating the transfer of data between devices, then the diagram may be illustrative of a “put” command, which can result in the placement of data from a device issuing the “put” command to a device that is a target of the “put” command. The issuance of the write command by the processor 105 can result in the movement of a fixed number of data units, which can be stored in a storage bank 205 in the processor 105, to the memory 110. The storage bank 205 can be a bank of registers in the processor 105 or it may be a scratch memory wherein the processor 105 can store intermediate data that it is manipulating while it is processing data.

The diagram shown in FIG. 2a illustrates the movement of sixteen (16) data units from the storage bank 205 to the memory 110, resulting from the issuance of a write command by the processor 105. The sixteen data units can begin with a data unit in a location 210 as specified by address AX. Note that the address AX is an address specified by the processor 105 to specify a beginning (or end) of a block of memory locations that it wishes to be transferred to the memory 110. After the issuance of the write command by the processor 105, the contents of the location 210 (memory address AX) and fifteen consecutive locations (from memory address AX+1 to AX+15) are moved to the memory 110. There may be intermediate steps and operations that are not shown in the diagram shown in FIG. 2a or discussed above. Note that the use of a fixed length burst transfer of sixteen data units is for illustrative use only and that a fixed length burst transfer can transfer an arbitrary number of data units that has been agreed upon by the parties involved in the data transfer. However, a number of data units transferred that is a power of two (2) number is preferred.

The diagram shown FIG. 2b illustrates the movement of sixteen (16) data units from the memory 110 to the processor 105, resulting from the issuance of a read command by the processor 105. If the diagram had been illustrating the transfer of data between devices, then the diagram may be illustrative of a “get” command, which can result in the retrieval of data by a device issuing the “get” command from a device that is a target of the “get” command. The sixteen data units can begin with a data unit in a location 255 as specified by address AX. As above, the address AX is an address specified by the processor 105 to specify a beginning (or end) of a block of memory locations that it wishes to be transferred from the memory 110. After the issuance of the read command by the processor 105, the contents of memory location 255 (memory address AX) and fifteen consecutive locations (from memory address AX+1 to AX+15) are moved from the memory 110 to the processor 105. Note that there may be intermediate steps and operations that are not shown in the diagram shown in FIG. 2b or discussed above.

The use of a fixed length burst transfer can help to increase efficiency by reducing overhead per data unit transferred. However, there can be instances when there is a desire to transfer data units that are fewer in number than what is transferred in the fixed length burst transfer. In these instances, it can be possible to use a data transfer that permits a variable number of data units or transfers a smaller number of data units than the number that is desiring transfer. For example, it can be possible to issue a data transfer of one data unit each a total of ten times to transfer ten data units. Alternatively, it can be possible to mask out part of a data transfer not transferring actual data. For example, the transfer of ten data units using a fixed length burst transfer of sixteen data units can be accomplished by masking out the six unused data units.

However, an occasion may arise wherein it may be desirous to stop a fixed length burst transmission after the fixed length burst transmission has been initiated. For example, an error may be detected that may result in the data being transferred being invalid, an interrupt may occur and need to be processed immediately resulting in an immediate need to transfer some data of its own, and so forth. Unfortunately, the technique of masking unused data units will keep the connection 115 (between the processor 105 and the memory 110) busy until the fixed length burst transmission is complete, even if all data units have been transmitted, while the use of small transfers can greatly reduce the efficiency of the data transmission.

With reference now to FIG. 3, there is shown a flow diagram illustrating a prior art technique 300 that can be used to transfer fewer data units than a default fixed length burst transfer while maintaining a high level of efficiency. The prior art technique makes use of a special command that can be transmitted prior to the transfer of the data units to set a burst length for the upcoming data transfer. By setting the length of the burst, the fixed length burst transfer can be set to a length that is exactly as long as needed. The prior art technique can begin by issuing a burst length command prior to the transfer of the data (block 305). After the issuance of the burst length command, the specified data can be transferred using the standard burst transfer command (block 310). Then, after the burst transfer is complete, the length of the burst transfer can be restored to the default value by another burst length command (block 315).

Alternatively, the changing of the length of the burst transfer can be configured so that the change in the length of the burst will only apply to the burst transfer immediately following the burst length command. A disadvantage of the prior art technique is that an additional command needs to be supported by the computer system 100 or the communications network 150. Additionally, the additional command needs to be executed at least once for each burst transfer that is not of the standard length (the additional command needs to be executed twice for each burst transfer if the length does not automatically reset to the default value). Furthermore, the additional command does not resolve the situation wherein there may be a need to stop the burst transfer after it has been started.

In many computer systems and communications networks, there exists a command that can be used to terminate a fixed length burst transfer. This burst terminate command can typically be used to terminate a data transfer (be it resulting from a read/write or get/put command) once the command is executed. It can be possible to modify the burst terminate command to terminate a burst transfer after the completion of a transfer of a desired number of data units.

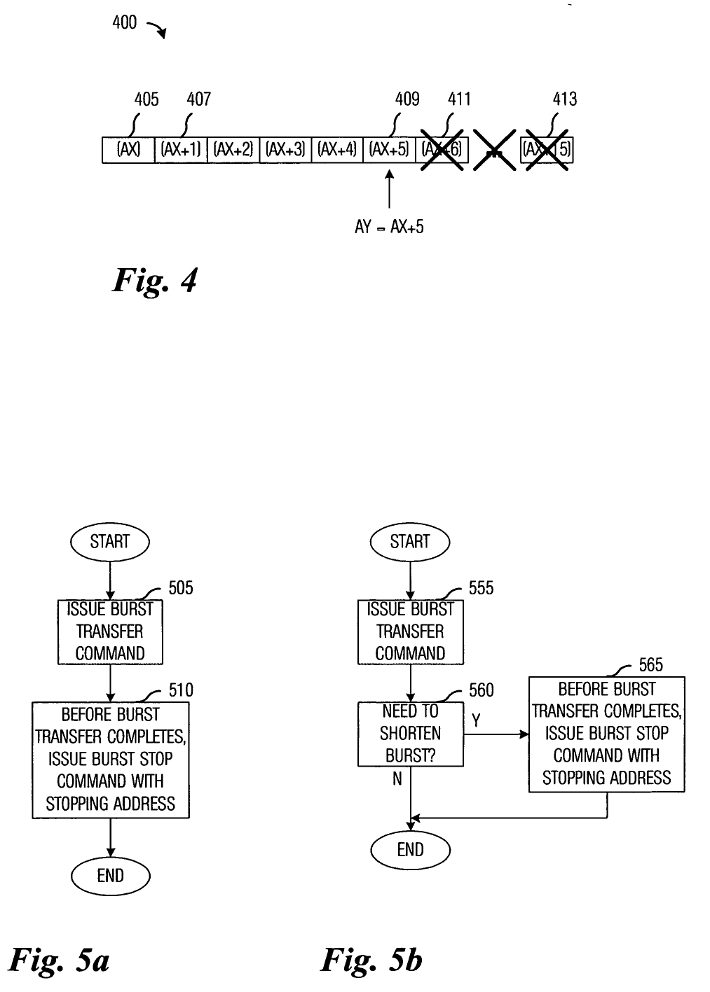

With reference now to FIG. 4, there is shown a diagram illustrating an exemplary fixed length burst transfer 400 after the execution of a modified burst terminate command, wherein it is desired to terminate the burst transfer after six data units have been transferred, according to a preferred embodiment of the present invention. The diagram shown in FIG. 4 shows a series of data units that may be transferred from a source (such as the processor 105) to a destination (such as the memory 110), wherein the series of data units begins with the contents 405 of a storage location with an address AX and is followed with the contents 407 of a storage location with an address AX+1, continuing through the contents 413 of a storage location with an address AX+15. Note that the burst transfer 400 shown in FIG. 4 is with a burst length of sixteen (16). However, other burst length burst transfers can be used without changing the spirit of the present invention.

After the initiation of the data transfer (by either a read or a write command), a burst terminate command is executed with an intent of stopping the data transfer after six data units have been transferred. According to a preferred embodiment of the present invention, the burst terminate command can be issued with an argument specifying a number representing the address of the storage location where the burst transfer is to be stopped. For example, if the data transfer started with a storage location with an address of AX, then six data units transferred will be a storage location 409 with an address of AX+5, so the burst terminate command will be issued with an argument of AX+5. Alternatively, the burst terminate command can be issued with a number representing the number of data units to be transferred, in this example, the number is six (6). Other variations can be possible, for example, the argument of the burst terminate command can specify the address of the last storage location to be transferred or the address of the first storage location immediately following the last storage location to be transferred, the argument of the burst terminate command can specify the count of the data units to transfer or the count of the first data unit not transferred, and so forth.

With the argument of the burst terminate command being an address of AX+5, the burst transfer can transfer a series of data units from storage locations with address AX through AX+5. Then, the contents 411 of a storage location 411, which would have been the next data unit transferred, is not transferred, as are subsequent data units. As an example, in a memory system of the computer system 100 that is compliant to the JEDEC Technical Standard, “Double Data Rate (DDR) SDRAM Specification—JESD79D,” published January 2004, the burst terminate command “BST” is defined as CS#=L (CS—chip select), RAS#=H, CAS#=H, and WE#=L (RAS, CAS, and WE are command inputs that can be used to define a command being entered, depending upon the state of the command inputs) can be extended with the previously unused address bus (ADDR) can be used to specify an argument representing a stopping point of the burst transfer. Note that the # operator indicates negative true logic signals.

With reference now to FIGS. 5a and 5b, there are shown flow diagrams illustrating the use of the burst terminate command to reduce the number of data units transferred in a fixed length burst transfer, according to a preferred embodiment of the present invention. The burst terminate command can be issued to terminate a fixed length burst transfer after a certain number of data units have been transferred or the burst terminate command can be issued to terminate a fixed length burst transfer after the occurrence of an event requires that a connection (such as the connection 115 or the communications link 165) be freed for use for some other purpose.

The flow diagram shown in FIG. 5a illustrates the use of a burst terminate command to terminate a fixed length burst transfer after a certain number of data units have been transferred. The data unit transfer can be initiated with an ordinary fixed length burst transfer command (block 505), then before the fixed length burst transfer completes, a burst terminate command is issued with a memory address of memory location containing a final data unit provided as an argument (block 510). For example, if the fixed length burst transfer was initiated with a memory address AX and seven data units are to be transferred, then the burst terminate command can be issued with a memory address of AX+6. Although the burst terminate command can be issued at any time prior to the completion of the fixed length burst transfer, it can be preferred that the burst terminate command be issued immediately after the issuance of the fixed length burst transfer command. Note that if the burst terminate command is issued after the fixed length burst transfer is complete, the unused data units can be ignored or masked. The terms ‘ignored’ and ‘masked’ can be used to describe a substantially similar action. In a read operation, unwanted data units can be ignored, while in a write operation, unwanted data units can be masked. The masking of unwanted data units ensures that the write operation always writes a required number of data units into a memory array.

The flow diagram shown in FIG. 5b illustrates the use of a burst terminate command to terminate a fixed length burst transfer to free up the connection (such as the connection 115 or the communications link 165) for other use. The data unit transfer can be initiated with an ordinary fixed length burst transfer command (block 555). After the data unit transfer is initiated, an initiator of the data unit transfer can resume normal operation. If an event occurs, such as an error, an interrupt may be asserted. As part of the interrupt servicing, the initiator can check to determine if the data unit transfer needs to be shortened to free up the connection (block 560). If the data unit transfer does not need to be shortened, for example, if the fixed length burst transfer has already completed or if the connection does not need to be used, then the data unit transfer can be permitted to complete. However, if the data unit transfer needs to be shortened, then a burst terminate command can be issued (block 565). According to a preferred embodiment of the present invention, the burst terminate command can be issued with an address of a data unit that is the next to be transferred. The address of the next data unit to be transferred should be used to minimize any wait for access to the connection.

In certain configurations, such as in a computer memory system implementing double data rate transfers, it may be desirable to let a fixed length burst transfer continue until an even data unit is reached. This can permit an easier implementation of the address strobe signal. However, if it is desired that a fixed length burst transfer stop on an odd data unit, then the even data unit can be masked to provide the desired odd burst length.

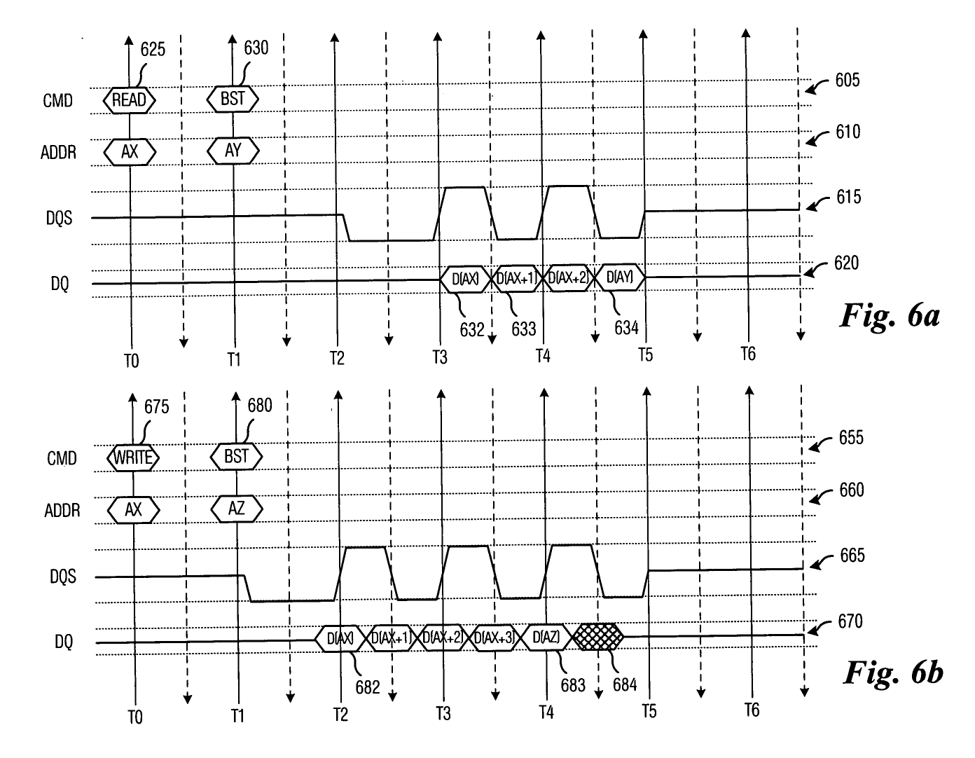

With reference now to FIGS. 6a and 6b, there are shown diagrams illustrating the use of a burst terminate command to shorten a fixed length burst transfer in a memory system, wherein the memory system is a double data rate memory system, according to a preferred embodiment of the present invention. The diagrams shown in FIGS. 6a and 6b illustrate the use of burst terminate command to shorten a fixed length burst transfer initiated by a read command (FIG. 6a) and a write command (FIG. 6b). The diagrams show the states of the command bus (CMD), the address bus (ADDR), data bus signal (DQS), and the data bus (DQ).

The diagram shown in FIG. 6a illustrates the execution of a read command with a latency of three (3) clock cycles and a fixed length burst transfer of eight (8). A first set of traces 605 illustrates the state of the CMD bus, a second set of traces 610 illustrates the state of the ADDR bus, while a third and fourth set of traces 615 and 620 illustrate the signals on the data bus and the state of the data bus, respectively. At a time T0, a read command is issued with an address of AX. This is shown on the first and second sets of traces as <READ>625 and <AX>. Immediately after the issuance of the read command, a burst terminate command is issued with an address of AY, wherein AY=AX+3, i.e., the intent of the burst terminate command is to terminate the fixed length burst transfer after the transfer of four data units. This is shown on the first and second sets of trances 605 and 610 as <BST>630 and <AY>, respectively. Note that while the example shown in FIG. 6a shows that the burst terminate command is issued immediately after the read command, the burst terminate command can be issued at any time after the issuance of the read command and prior to the transfer of the data unit where the fixed length data burst transfer is to be stopped.

Due to the three clock cycle latency of the read command, the data bus signal (the third set of traces 615) does not show the contents of the memory location AX until time T3 (the data bus (the fourth set of traces 620) shows the content 632 of memory location AX). Since the memory system is a double data rate memory system, half-way through a clock cycle beginning at time T3, the data bus signal and the data bus show the content 633 of memory location AX+1. After the content 634 of the memory location AX+3 (AY) has been transferred, the fixed length burst transfer is stopped.

The diagram shown in FIG. 6b illustrates the execution of a write command with a write latency of two (2) clock cycles and a fixed length burst transfer of eight (8). Note that the different latencies for the two commands shown in FIGS. 6a and 6b are for illustrative purposes and are not intended to represent any particular memory system. A fifth set of traces 655 illustrates the state of the CMD bus, a sixth set of traces 660 illustrates the state of the ADDR bus, while a seventh and eighth set of traces 665 and 670 illustrate the signals on the data bus and the state of the data bus, respectively. At a time T0, a write command is issued with an address of AX. This is shown on the first and second sets of traces as <WRITE>675 and <AX>. Immediately after the issuance of the read command, a burst terminate command is issued with an address of AZ, wherein AZ=AX+4, i.e., the intent of the burst terminate command is to terminate the fixed length burst transfer after the transfer of five data units. This is shown on the fifth and sixth sets of traces 655 and 660 as <BST>680 and <AZ>, respectively.

Due to the two clock cycle latency of the write command, the data bus signal and the data bus (the seventh and eighth sets of traces 665 and 670) do not show the content 682 of the memory location AX until time T2. At a time that is at time T4, the data bus signal and the data bus (the seventh and eighth sets of traces 665 and 670, respectively) show the content 683 of the memory location AX+4 (AZ). This is the desired stopping point of the fixed length burst transfer. However, to maintain simplicity of strobe signal of the memory system, fixed length burst transfers are stopped after even data units. Therefore, the data bus signal and the data bus (the seventh and eighth sets of traces 665 and 670) show the content 684 of the memory location AX+5 (AZ+1). Note however that the content 684 of the memory location AX+5 has been masked (shown as a shaded region). Alternatively, the content 684 of the memory location AX+3 can simply be ignored by recipients of the fixed length burst transfer.

The burst terminate commands shown in FIGS. 6a and 6b as being issued immediately after the issuance of the read and write commands can be issued at any time prior to the completion of the fixed length burst transfers. For example, for the read command shown in FIG. 6a, the burst terminate command can be issued as late as time T4, while for the write command shown in FIG. 6b, the burst terminate command can be issued as late as time T4. The diagrams shown in FIGS. 6a and 6b illustrate a situation wherein the burst terminate command is used to intentionally shorten a burst transfer, a situation wherein a burst terminate command is used to involuntarily shorten a burst transfer will look substantially similar, but it is unlikely that the burst terminate commands will be issued immediately after the issuance of the read and write commands.

Although the present invention and its advantages have been described in detail, it should be understood that various changes, substitutions and alterations can be made herein without departing from the spirit and scope of the invention as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for shortening a fixed burst length data transfer, the method comprising:
initiating a fixed burst length data transfer; and
issuing a burst terminate command specifying a desired length of the burst data transfer, wherein the burst terminate command is issued prior to the completion of the fixed burst length data transfer.

2. The method of claim 1, wherein the initiating comprises specifying a memory address.

3. The method of claim 2, wherein the memory address specifies a starting point of data to be transferred.

4. The method of claim 2, wherein the memory address specifies an ending point of data to be transferred.

5. The method of claim 1, wherein the burst terminate command is issued immediately after the initiation of the fixed burst length data transfer.

6. The method of claim 1, wherein the fixed burst length data transfer transfers a specified number of data units, and wherein the burst terminate command specifies a memory address of a data unit, wherein the memory address is an address of a last data unit to be transferred.

7. The method of claim 1, wherein the fixed burst length data transfer transfers a specified number of data units, and wherein the burst terminate command specifies a memory address of a data unit, wherein the memory address is an address of a first data unit not to be transferred.

8. The method of claim 1, wherein the burst terminate command is issued after an occurrence of an event.

9. The method of claim 8, wherein the event is an error.

10. The method of claim 8, wherein the event is an interrupt.

11. The method of claim 1, wherein the fixed burst length data transfer occurs in a memory system of a computer system.

12. The method of claim 11, wherein the memory system is a double data rate memory system, and wherein burst terminate command stops the fixed burst length data transfer after an even number of data has been transferred.

13. The method of claim 12, wherein if the termination of the fixed burst length data transfer is desired after an odd number of data has been transferred, then the termination occurs for a first even number greater than the odd number and a final data is ignored or masked.

14. The method of claim 13, wherein the final data is ignored or masked.

15. The method of claim 1, wherein the fixed burst length data transfer occurs in a communications network between pairs of communicating devices.

16. A method for shortening fixed length burst transfers in a memory system, the method comprising:
placing a burst transfer command on a command bus and a first memory address on an address bus, wherein the first memory address specifies a starting address of data to be transferred; and
after a burst transfer starts, placing a burst terminate command on the command bus and a second memory address on the address bus, wherein the second memory address specifies a terminating address of data to be transferred.

17. The method of claim 16, wherein the burst transfer transfers a fixed number of data, and wherein the second memory address is within the fixed number of data to be transferred.

18. The method of claim 16, wherein the second placing occurs before the burst transfer completes.

19. The method of claim 16, wherein the burst terminate command is specified as follows:
RAS#=H, CAS#=H, WE#=L, and CS#=L,
wherein RAS, CAS, and WE are command inputs to the memory system, wherein CS is a chip select signal, wherein the # operator indicates negative true logic, and wherein H represents a high logic value and L represents a low logic value.

20. The method of claim 19, wherein the memory system is a JEDEC compliant memory system.

21. The method of claim 20, wherein the memory system is a double data rate memory system.

22. The method of claim 21, wherein the second memory address specifies that the burst transfer terminates after an even number of data has been transferred.

23. The method of claim 22, wherein if the burst transfer is to be terminated after an odd number of data has been transferred, then a last data transferred is masked or ignored.

24. The method of claim 16, wherein the burst transfer transfers data in data units, and wherein the second address specifies an address of a last data unit to be transferred.
